(19) United States
(12) Patent Application Publication
(10) Pub. No.: US 2012/0086301 A1
(43) Pub. Date: Apr. 12, 2012

(54) POWER GENERATING APPARATUS AND MOTOR

(76) Inventor: Jin dong Kim, Gyeongsangbuk-do (KR)

(21) Appl. No.: 13/265,635

(22) PCT Filed: Apr. 21, 2010
(86) PCT No.: PCT/KR2010/002505

§ 371 Date: Dec. 6, 2011

(30) Foreign Application Priority Data
Apr. 22, 2009 (KR) 2020090004842

(51) Int. Cl. H02K 1/02

(52) U.S. Cl. 310/216.001

(57) ABSTRACT

Disclosed are a power generating apparatus and a motor. The power generating apparatus includes a stator made of a nonferrous metal, with a coil being wound thereon, and a rotor made of a nonferrous metal. The rotor is rotatable relative to the stator, and a plurality of magnets are disposed in surfaces of the rotor, so that the rotor interacts with the stator, thereby generating electricity. In the power generating apparatus and the motor, not only the stator but also the rotor is made of a nonferrous metal, such as stainless steel, aluminum, or the like. This ensures that rotation of the rotor is more efficient, thereby increasing the operation efficiency of the power generating apparatus and the motor.

### TECHNICAL FIELD

The present invention relates to a power generating apparatus and a motor.

### BACKGROUND ART

A power generating apparatus changes kinetic energy, heat energy, or chemical energy into electric energy.

The power generating apparatus comprises a stator and a rotor. Coils are wound around the stator, and permanent magnets are installed in the rotor. The rotor rotates around the stator. When the rotor is rotated by external energy, electric energy is generated at the coils.

A motor changes electric energy into driving power by rotating a rotor inside a stator. The motor is used broadly across all industries that need a driving force. Such a motor includes a stator and a rotor.

However, in the conventional power generating apparatus, the stator is made of iron, so that, when the rotor rotates, magnetic attraction occurs between the stator and the permanent magnets. The magnetic attraction acts as resistance, thus reducing the efficiency of the power generating apparatus.

### DISCLOSURE

### Technical Problem

An object of the present invention is to provide a power generating apparatus and a motor that are configured such that a rotor can more efficiently rotate in order to improve their operation efficiency.

### Technical Solution

According to an aspect of the present invention, the power generating apparatus includes a stator made of a nonferrous metal, with a coil being wound thereon; and a rotor made of a nonferrous metal. The rotor is rotatable relative to the stator, and a plurality of magnets are disposed in surfaces of the rotor, so that the rotor interacts with the stator, thereby generating electricity.

According to another aspect of the present invention, the motor includes a stator made of nonferrous metal, wherein the stator includes a stator body and stator projections that project from the stator body, with a coil being disposed between adjacent ones of the stator projections; a rotor made of nonferrous metal, wherein the rotor has a plurality of magnets disposed in surfaces thereof so that the rotor rotates with respect to the stator when power is applied to the coil; and an iron fixture made of iron, wherein the iron fixture is disposed between adjacent ones of the stator projections.

The iron fixture includes a base portion in contact with a base between the adjacent stator projections, a projecting portion projecting a predetermined height from the base portion, and a flat portion facing a corresponding one of the magnets of the rotor. The flat portion is configured to expand in a lateral direction from a distal end of the projecting portion at a position protruding above the coil such that the flat portion covers a predetermined area of the coil that surrounds the projecting portion.

### Advantageous Effects

In the power generating apparatus and the motor according to an aspect of the present invention, not only the stator but also the rotor is made of a nonferrous metal, such as stainless steel, aluminum, or the like. This ensures that rotation of the rotor is more efficient, thereby increasing the operation efficiency of the power generating apparatus and the motor.

In addition, in the power generating apparatus and the motor according to another aspect of the present invention, the stator is made of a nonferrous metal so that, when the power generating apparatus and the motor work, heat generated inside the apparatus and the motor is readily emitted to the outside, thereby making heat dissipation effective.

Furthermore, in the power generating apparatus and the motor according to a further aspect of the present invention, because the stator is made a nonferrous metal, the weight of the stator is decreased, thereby facilitating the fabrication and management.

In addition, in the power generating apparatus and the motor according to further another aspect of the present invention, the magnet insertion hole is formed in the body of the rotor so that the magnet is installed by simply inserting the magnet into the magnet insertion hole, thereby simplifying the process of assembling the magnet.

Furthermore, in the power generating apparatus and the motor according to yet another aspect of the present invention, the stator-forming panels can be easily made because they have good workability due to their relatively small thicknesses. Since the stator-forming panels can be simply stacked on one another, the fabrication of the stator is easy.

In addition, in the power generating apparatus and the motor according to still another aspect of the present invention, the stator projections project from the body of the stator. If the stator projections are made of a nonferrous metal like the body of the stator, the interference between adjacent coils on both sides of the stator projection can be minimized. As an effect, the operation efficiency of the power generating apparatus and the motor can be further increased.

Furthermore, in the power generating apparatus and the motor according to another aspect of the present invention, the power generating apparatus and the motor do not have an outer case that houses the stator and the rotor therein, but the stator not only serves to house the coils therein but also functions as an outer case of the power generating apparatus. Consequently, the power generating apparatus and the motor can have a simplified structure and a compact size.

In addition, in the power generating apparatus and the motor according to a further aspect of the present invention, if the body of the rotor is made of a nonferrous metal and the magnet cover is made of iron, the rotation of the rotor can be conducted more efficiently, and the magnetic cover can be magnetized so that the magnetic force can be concentrated to the coil in association with the magnets. Consequently, the operation efficiency of the power generating apparatus and the motor can be further increased.

Furthermore, in the power generating apparatus and the motor according to further another aspect of the present invention, on opposite ends of the stack of stator-forming panels, further stator-forming panels each having a corresponding stator partition are stacked. The stator partition then connects adjacent stator projections to each other, and in cooperation with the stator projections, define a recess that contains a coil therein. The coil is then isolated from the outside by the stator partition. Since the stator partition is made of a nonferrous metal like the stator-forming panel, the stator partition functions as a shield that blocks the interaction between adjacent coils. As the interaction between adjacent coils can be minimized, the operation efficiency of the power generating apparatus can be further increased.

### DESCRIPTION OF DRAWINGS

FIG. 1 is a combined perspective view illustrating a power generating apparatus according to an embodiment of the present invention;

FIG. 2 is a perspective view illustrating a stator of the power generating apparatus according to an embodiment of the present invention;

FIG. 3 is a perspective view illustrating a rotor of the power generating apparatus according to an embodiment of the present invention;

FIG. 4 is a cross-sectional view of the power generating apparatus according to an embodiment of the present invention;

FIG. 5 is a partial enlargement view illustrating the stator, around which coils are wound, of the power generating apparatus according to an embodiment of the present invention;

FIG. 6 is a view illustrating a stator-forming panel being provided in the stator of the power generating apparatus according to an embodiment of the present invention;

FIG. 7 is a view illustrating a stator partition of the stator according to an embodiment of the present invention;

FIG. 8 is a view illustrating the stack including the stator-foaming panels shown in FIG. 6 and the stator partition shown in FIG. 7;

FIG. 9 is a view illustrating the stator-forming panels of FIG. 6, which are stacked on one another;

FIG. 10 is a perspective view illustrating an iron fixture of the stator of the power generating apparatus according to an embodiment of the present invention;

FIG. 11 is a perspective view illustrating the coils of the stator of the power generating apparatus according to an embodiment of the present invention;

FIG. 12 is a perspective view illustrating the rotor, in which the magnet is inserted, of the power generating apparatus according to an embodiment of the present invention;

FIG. 13 is a perspective view illustrating the magnet inserted in the rotor of the power generating apparatus according to an embodiment of the present invention; and

FIG. 14 is a partial expansion view illustrating coils wound on a stator in a motor according to another embodiment of the present invention.

### BEST MODE

Reference will now be made in detail to a power generating apparatus and a motor according to embodiments of the present invention, examples of which are illustrated in the accompanying drawings. Although the power generating apparatus of the present invention will be described below with reference to the drawings, the descriptions of the power generating apparatus can be applied to the motor of the present invention in the same fashion. In other words, when electricity is supplied to the coil of the stator of the power generating apparatus, the power generating apparatus can work as a motor. Accordingly, descriptions of the motor will be omitted, since its structure is identical to that of the power generating apparatus, which will be described below.

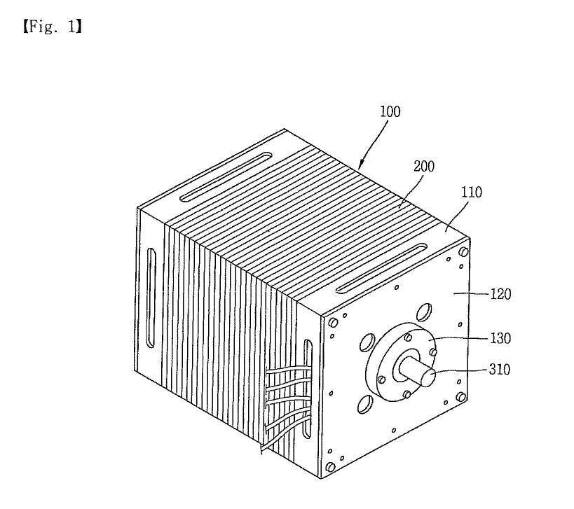

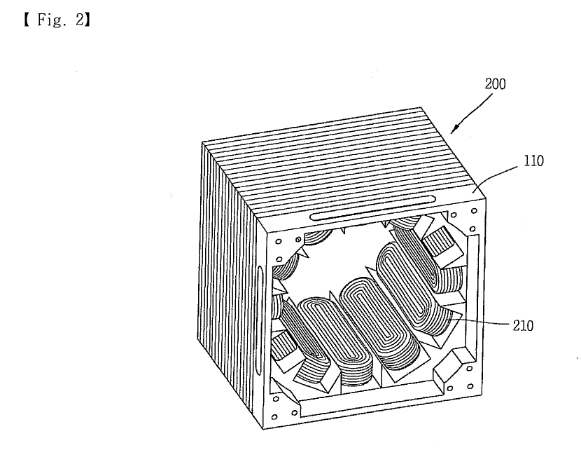

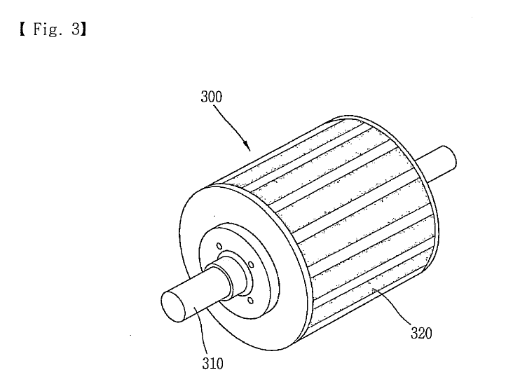

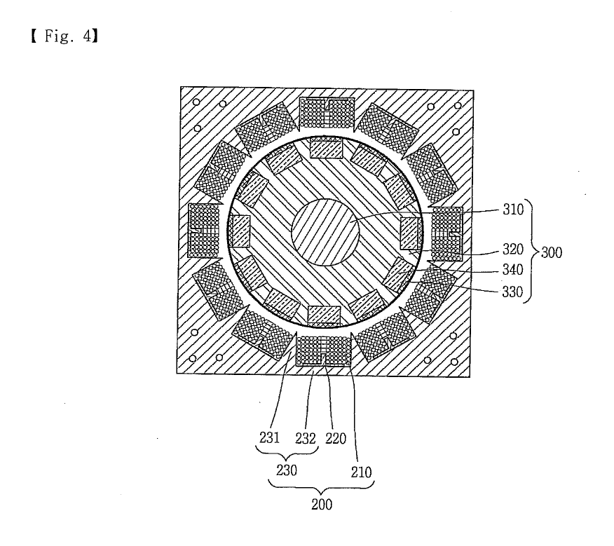

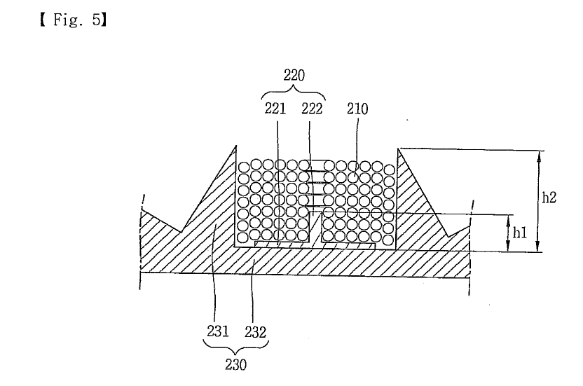

FIG. 1 is a combined perspective view illustrating a power generating apparatus according to an embodiment of the present invention, FIG. 2 is a perspective view illustrating a stator of the power generating apparatus according to an embodiment of the present invention, FIG. 3 is a perspective view illustrating a rotor of the power generating apparatus according to an embodiment of the present invention, FIG. 4 is a cross-sectional view of the power generating apparatus according to an embodiment of the present invention, and FIG. 5 is a partial enlargement view illustrating the stator, around which coils are wound, of the power generating apparatus according to an embodiment of the present invention.

As shown in FIGS. 1 to 5, the power generating apparatus 100 of the present embodiment includes a stator 200 and a rotor 300. Combining panels 110 are formed at the front side and the rear side of the stator 200, and covers 120 are separately combined with the combining panels 110.

The stator 200 is fixed to apparatuses (for example, an electric automobile, an electric scooter, a vessel, an air-conditioning apparatus for homes, etc.) to which the power generating apparatus 100 is fitted. The rotor 300 interacts with the stator 200 and rotates, so that the power generating apparatus 100 generates electricity.

Axle fixing portions 130 are foamed at the center portions of the covers 120. A rotating axle 310 is installed in the axle fixing portions 130 to be able to rotate. The rotation of the rotating axle 310 is smooth because bearings are installed between the axle fixing portions 130 and the rotating axle 310, etc.

The stator 200 includes coils 210, iron fixtures 220 and coil-mounting portions 230.

The coils 210 are formed by a method of winding copper wires, and each end portion of the coils 210 is connected to an external electrical apparatus. When the rotor 300 rotates, electricity is induced at the coils 210, and the electricity is supplied to the external electrical apparatus through the end portions of the coils 210.

Stator projections 231 and a coil-arranging base 232 are formed at the coil-mounting portion 230.

The stator projections 231 project from the body of the stator 200. The coils 210 are stably arranged in the space between adjacent stator projections 231.

For efficient use of space, the stator projections 231 become narrow in the direction of the inner side of the stator 200. For example, the sections of the stator projections 231 are formed in a triangular shape.

The coil-arranging base 232 is the portion of the body of the stator 200 that is formed between the stator projections 231. The coils 210 are stably arranged in the coil-arranging base 232.

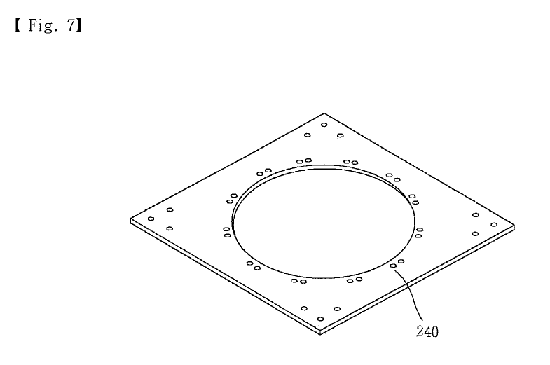

After the coils 210 are stably arranged on the coil-arranging base 232, stator partitions (240 in FIG. 7) are layered on opposite ends of the stator 230, and an insulating material is disposed between the stator projections 231 so that the coils 210 are submerged. In this way, the coils 210 are fixed stably, and can be insulated. Of course, covers for covering the coils 210 may be used.

Through-holes may be formed in the stator partitions 240, opposite ends of the coils 210 may extend through the through-holes such that they can be connected to an external power source. The stator partitions 240 may be made of a nonferrous metal.

The plural coils 210 arranged in the stator 200 can be electrically connected in series or parallel according to the intended application of the power generating apparatus 100. By the method of the connection, the amount of output power of the power generating apparatus 100 is adjusted to coincide with some desired value.

In this embodiment, the stator 200 is made of a nonferrous metal such as stainless steel or aluminum.

Because the interaction of a nonferrous metal with the magnet is weaker than the interaction of iron with the magnet, when the power generating apparatus 100 operates, the interaction between the magnet 340 of the rotor 300 and the body of the stator 200 is minimized. Therefore, the rotating motion of the rotor 300 is smooth, and the efficiency of the power generating apparatus 100 is improved.

Moreover, when the power generating apparatus 100 operates, heat generated inside the power generating apparatus 100 is readily emitted outside the power generating apparatus 100.

Furthermore, because the weight of the stator 200 is decreased, the production and handling of the stator 200 are convenient.

In addition, the stator protrusions 231 protrude from the body of the stator 200, and the stator protrusions 231 and the stator partitions 240 as well as the body of the stator 200 may also be made of a nonferrous metal. The stator protrusions 231 then functions as a shield that block the interference between adjacent coils 210 so that the interaction between adjacent coils 210 on both sides of a corresponding stator protrusion 231 can be minimized, thereby further improving the operation efficiency of the power generating apparatus 100.

In this embodiment, the power generating apparatus 10 is not provided with an outer case that houses the stator 200 and the rotor 300 therein, but the stator 200 not only serves to house the coils 210 therein but also functions as an outer case of the power generating apparatus 100. Consequently, the power generating apparatus 100 can have a simplified structure and a compact size.

The iron fixture 220 is made of iron and is attached to the coil-arranging base 232. The iron fixture 220 includes a base portion 211 connected to the coil-arranging base 232 and a projecting portion 222 projecting from the center portion of the base portion 211.

As shown in FIG. 5, the height h1 of the iron fixture 220, that is, the height of the projecting portion 222, is lower than the height h2 of the stator projection 231.

So, by the combination of the iron fixture 220, the coils 210 are wound more stably. Moreover, because the magnetic force is concentrated at the coils 210, the efficiency of the power generating apparatus 100 is improved.

The rotor 300 is connected to the stator 200 by the rotating axle 310 such that it is capable of rotating relative to the stator 200. The rotor 300 includes the rotating axle 310, the rotor body 320, the magnet cover 330 and the magnet 340.

Recesses, that is, magnet insertion holes in which the magnets 340 are inserted, are formed in the surface of the rotor body 320 along the circumference of the rotor body 320. A magnet cover 330 is fixed in each recess, thereby creating a space for the insertion of the magnet 340.

According to this configuration, the magnet 340 can be mounted by simply inserting the magnet into a recess formed in the rotor body 320, thereby simplifying the process of fitting the magnet 340.

Here, as an alternative to this method, holes in which the magnets 340 are combined are formed in the rotor body 320 according to the circumference of the rotor body 320. This falls within the scope of the invention.

In this embodiment, the rotor body 320 is made of a nonferrous metal, and the magnetic cover 330 is made of iron. Then, the rotation of the rotor 300 can be conducted more efficiently, and the magnetic cover 330 can be magnetized so that the magnetic force can be concentrated to the coil 210 in association with the magnets 340. Consequently, the operation efficiency of the power generating apparatus 100 can be further increased.

Here, the rotor body 320 can be made of stainless steel, aluminum, or the like. The magnetic cover 330 can be made of mild iron having a carbon content of 0.01% or less. This iron is soft, has great malleability and ductility, and can be easily magnetized.

The magnetic cover 330 can be coupled to the rotor body 320 by welding or using mating protrusions. After the magnets 340 are installed, the opposite ends of the magnets 340 that are exposed can be concealed with separate covers.

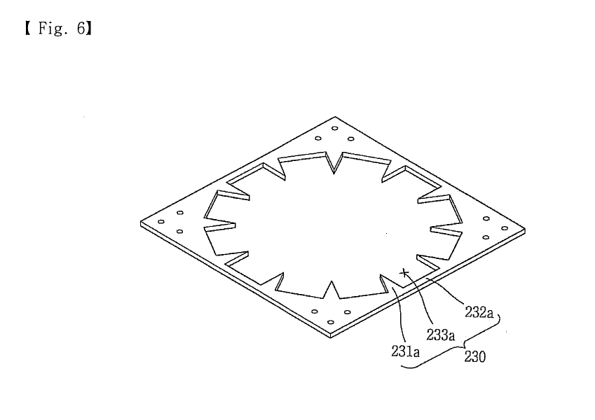

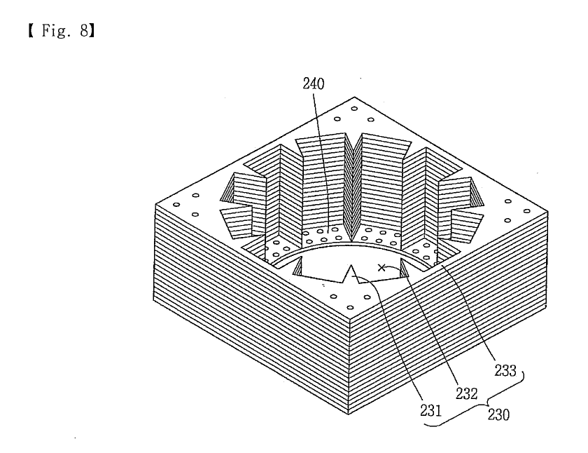

FIG. 6 is a view illustrating a stator-forming panel being provided in the stator of the power generating apparatus according to an embodiment of the present invention, FIG. 7 is a view illustrating a stator partition of the stator according to an embodiment of the present invention, and FIG. 8 is a view illustrating the stack including the stator-forming panels shown in FIG. 6 and the stator partition shown in FIG. 7.

Referring to FIG. 6 to FIG. 8, the stator 200 of this embodiment may be implemented by stacking the stator-forming panels 230a, as shown in FIG. 6, on one another, as shown in FIG. 8.

In this way, the stator-forming panels 230a that can be easily machined because of their thin profile are prepared and are then stacked on one another, thereby facilitating the fabrication of the stator 200.

In addition, further stator-forming panels 230a each having a corresponding stator partition 240 are stacked on opposite ends of the stack of the stator-forming panels 230a, which is formed as above. The stator partition 240 connects adjacent stator projections 231 to each other, and in cooperation with the stator projections 231, define a recess that contains a coil 210 therein. The coil 230 is then isolated from the outside by the stator partition 240. Since the stator partition 240 is made of a nonferrous metal like the stator-forming panel 230a, the stator partition 240 functions as a shield that blocks the interaction between adjacent coils 210. As the interaction between adjacent coils 210 can be minimized, the operation efficiency of the power generating apparatus 100 can be further increased.

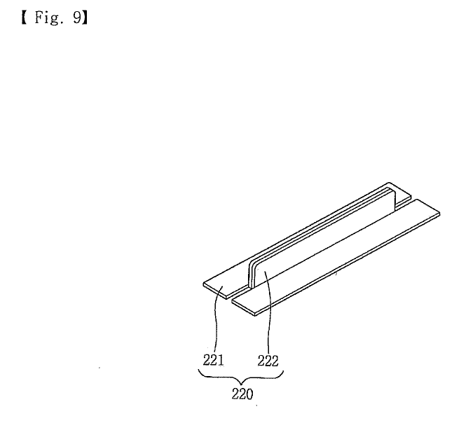

FIG. 9 is a perspective view illustrating an iron fixture of the stator of the power generating apparatus according to an embodiment of the present invention.

As shown in FIG. 9, the iron fixture 220 of the stator 200 includes the base portion 221 and the projecting portion 222, and is formed in an upside-down “T” shape.

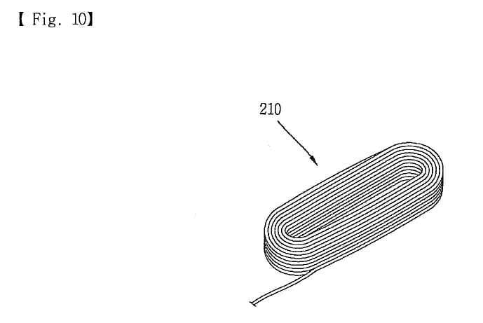

FIG. 10 is a perspective view illustrating the coils of the stator of the power generating apparatus according to an embodiment of the present invention.

As shown in FIG. 10, the coils 210 of the stator 200 are electric wires, and are formed in a wound shape. If the coils 210 are taped, the production of the coils 210 is simple without requiring a core.

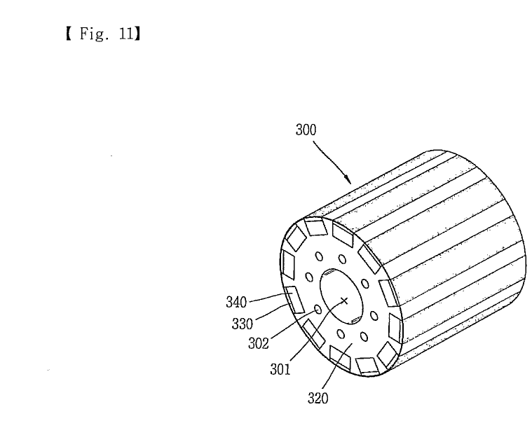

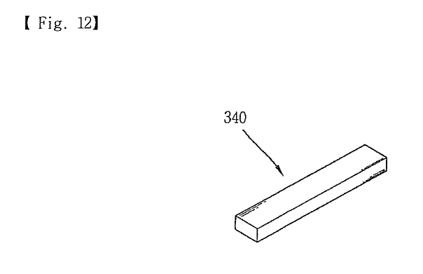

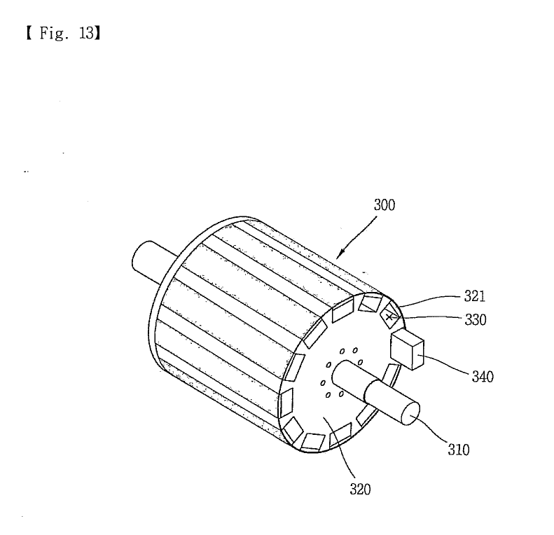

FIG. 11 is a perspective view illustrating the rotor in which the magnet is inserted of the power generating apparatus according to an embodiment of the present invention, FIG. 12 is a perspective view illustrating a magnet which is inserted in the rotor of the power generating apparatus according to an embodiment of the present invention, and FIG. 13 is a perspective view illustrating features by which the magnet is inserted in the rotor of the power generating apparatus according to an embodiment of the present invention.

As shown in FIGS. 11 to 13, because the magnet 340 of FIG. 11 has a rectangular parallelepiped shape and is inserted into the magnet insertion hole 321 of the stator 300, the rotor 300 is simple to produce.

As shown in FIG. 13, each of the magnets 340 is inserted into a corresponding magnet insertion hole 321 of the stator 300, which is located adjacent to the surface of the stator 300.

Therefore, the power generating apparatus 100 of the present invention has the following advantageous effects.

First, because the stator 200 of the power generating apparatus 100 of the present invention is made of a nonferrous metal, when the power generating apparatus 100 operates, the interaction between the magnet 340 of the rotor 300 and the body 320 of the stator 300 is minimized. Therefore, the rotating motion of the rotor 300 is smooth, and the efficiency of the power generating apparatus 100 is improved.

Second, because the stator 200 of the power generating apparatus 100 of the present invention is made of a nonferrous metal, when the power generating apparatus 100 is operated, heat generated inside the power generating apparatus 100 is readily emitted outside the power generating apparatus 100.

Third, because the stator 200 of the power generating apparatus 100 of the present invention is made of a nonferrous metal, the weight of the stator 200 is decreased. Therefore, the production and handling of the stator 200 are convenient.

Fourth, because the iron fixture 220 of the power generating apparatus 100 of the present invention is arranged in the stator 200, the coils 210 are wound stably, and the magnetic force is concentrated at the coils 210. Therefore, the efficiency of the power generating apparatus 100 is improved.

Fifth, because the body 320 of the rotor 300 of the power generating apparatus 100 of the present invention has magnet insertion holes 321 into which respective magnets 340 are inserted, the assembly process is simple.

Sixth, because the stator 200 of the power generating apparatus 100 of the present invention is a multi-layered structure of the thin stator-forming panels 230a, the production thereof is convenient.

### MODE FOR INVENTION

A description is given below of a motor according to another embodiment of the present invention with reference to the accompanying drawings. In the following disclosure, descriptions of the some components and functions will be omitted, since they are identical to the above-description of the foregoing embodiment of the present invention.

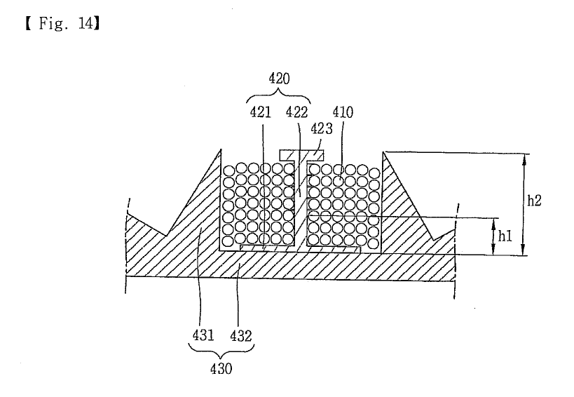

FIG. 14 is a partial expansion view illustrating coils wound on a stator in a motor according to another embodiment of the present invention.

Referring to FIG. 14, an iron fixture 420 is disposed in a coil-mounting portion 430 that is applicable to the motor of this embodiment.

A stator applied to this motor is made of a nonferrous metal. A plurality of stator projections 431 project from the body of the stator, and coils 410 are arranged between adjacent stator projections 431, respectively.

A rotor employed in the motor is made of a nonferrous metal, with a plurality of magnets being disposed on the surface thereof. The rotor rotates with respect to the stator when power is applied to the coils 410.

Iron fixtures 420 are made of iron, and are disposed between adjacent stator projections 431.

Each of the iron fixture 420 includes a base portion 421 which is in contact with a base 432 between the adjacent stator projections 431 in which the coil is disposed. A projecting portion 422 projects a predetermined height from substantially the central portion of the base portion 421. A flat portion 423 faces a corresponding one of the magnets of the rotor. The flat portion 423 is configured to expand in a lateral direction from the distal end of the projecting portion 422 at a position protruding above the coil 410 such that the flat portion 423 covers a predetermined area of the coil 410 that surrounds the projecting portion 422.

The flat portion 423 that is formed as above can increase the area of the portion of the iron fixture 420 that is magnetized by electricity applied to the coil 410 while facing the magnet of the motor, thereby increasing rotational force. Consequently, the operation efficiency of the motor to which the iron fixture 420 is applied can be increased.

It will be apparent to those skilled in the art that various modifications and variations to the present invention can be made without departing from the spirit or scope of the invention. Thus, it is intended that the present invention covers the modifications and variations of this invention provided they fall within the scope of the appended claims and their equivalents.

### INDUSTRIAL APPLICABILITY

Therefore, the present invention has the following industrial applicability. The efficiency of the power generating apparatus and the motor is improved.

1. A power generating apparatus, comprising:
a stator made of a nonferrous metal, with a coil being wound thereon; and
a rotor made of a nonferrous metal, wherein the rotor is rotatable relative to the stator, and a plurality of magnets are disposed in surfaces of the rotor, so that the rotor interacts with the stator, thereby generating electricity.

2. The power generating apparatus of claim 1, wherein the rotor has a plurality of magnet insertion holes formed along a circumference thereof, wherein each of the magnet insertion holes includes a groove in a surface of the rotor and a magnet cover that closes the recess, the magnet cover being made of iron.

3. A motor comprising:
a stator made of nonferrous metal, wherein the stator includes a stator body and stator projections that project from the stator body, with a coil being disposed between adjacent ones of the stator projections;
a rotor made of nonferrous metal, wherein the rotor has a plurality of magnets disposed in surfaces thereof so that the rotor rotates with respect to the stator when power is applied to the coil; and
an iron fixture made of iron, wherein the iron fixture is disposed between adjacent ones of the stator projections,
wherein the iron fixture includes a base portion in contact with a base between the adjacent stator projections, a projecting portion projecting a predetermined height from the base portion, and a flat portion facing a corresponding one of the magnets of the rotor, wherein the flat portion is configured to expand in a lateral direction from a distal end of the projecting portion at a position protruding above the coil such that the flat portion covers a predetermined area of the coil that surrounds the projecting portion.
